(19) United States
(12) Patent Application Publication
(10) Pub. No.: US 2010/0180488 A1
(43) Pub. Date: Jul. 22, 2010

(54) Weedless fishing lure containing multiple hooks

(75) Inventors: James R. Keeton, Savannah, TN (US); Louie W. Gibbs, Clermont, FL (US)

Correspondence Address: Julian C. Renfro, P.O. Box 2601, Winter Park, FL, 32790-2601, US

(73) Assignee: Classic Fishing Products, Inc.

(21) Appl. No.: 12/321,159

(22) Filed: Jan. 21, 2009

(51) Int. Cl. A01K 85/00; A01K 85/01

(52) U.S. Cl. 43/42.16; 43/42.74; 43/42.39; 43/42.31; 43/42.13

(57) ABSTRACT

A weedless fishing lure having arms supporting first and second single hooks substantially equidistant from an attachment point. The first hook is mounted upon a fish-resembling lure member, with a spinner member attached behind the fish-resembling lure member. The spinner member is configured to produce motion when the lure is pulled through the water, which motion is transferred to the fish-resembling lure member, thereby to produce motion attractive to fish. The second hook is disposed in a plane common to the first hook, with the second hook being operatively disposed in a skirted member.

### BACKGROUND OF THE INVENTION

This invention relates to a novel fishing lure, and more particularly to an improved fishing lure assuring weedless operation, while providing a spaced pair of single hooks in the interests of improving the ability of this lure to catch fish.

A problem that has plagued the use of prior art fishing lures for casting and the like has been that when retrieving or reeling in the lure, the lure oftentimes becomes entangled or encumbered with weeds that foul the hook and prevent the hooking of fish. In addition, the prior art lures often became snagged on obstructions such as branches or logs floating at or near the surface of a lake or pond.

The typical crank bait of the prior art utilized treble hooks, which on the one hand were effective in hooking fish, but on the other hand had the unfortunate characteristic of becoming easily snagged.

Also known to the prior art was the spinner bait, involving weighted, skirted member, equipped with a single hook, with such lure also including a spinner blade.

It has become the goal of the present invention to provide a lure having crank bait action and sound particularly attractive to fish, without necessitating the use of treble hooks prone to becoming snagged in weeds, with our new lure also incorporating spinner bait action, meaning that this lure may be regarded as two lures in one.

1. Field of the Invention

This invention relates to spinner bait lures and more particularly, to a spinner bait lure which may be provided with a rattle member, which includes multiple shot elements, with movement of the shot inside the rattle member or pod housing creating a rattling noise as the lure is retrieved through a water body. This rattling noise is accentuated by operation of a spinner member or blade mounted behind the rattle member. This arrangement is especially effective in murky water, where fish are attracted to a lure primarily by vibration and sound, rather than by sight.

It has long been known that spinner bait lures are one of the most effective types of baits for catching fish, and particularly black bass. Spinner bait lures are generally characterized by a lead body portion which may be shaped into a desired configuration, a hook extending rearwardly of the body portion, a skirt mounted on the body portion for concealing the hook and lending a life-like appearance to the lure as the lure is retrieved, and a wire harness extending from the body portion for mounting a spinner, attaching a fishing line and retrieving the lure. The spinner bait lure is characteristically used in water where unwanted structures may be present, and is retrieved at varying speeds at depths ranging from a few inches to several feet beneath the surface of the water. The spinner blade rotates as the lure is pulled toward the fisherman, possibly passing over floating or partially submerged structures in doing so. The flashing spinner attracts fish from a wide area of water and the plastic, stranded skirt undulates and ripples as the lure is retrieved, thereby further enhancing the attractiveness of the lure to the fish.

2. Description of the Prior Art

Various types of artificial fishing lure having spinners are well known to those skilled in the art. U.S. Pat. No. 2,835,068, dated May 20, 1958, to H. M. Latham, details “Artificial Fish Lures” which are characterized by solid head and body portions connected by an elongated member, with a treble hook located at the rear of the lure and a skirt secured to the treble hook for concealing the hook tips and barbs. A spinner mechanism is attached to the head of the body to facilitate rotation of the head about the elongated member and the longitudinal axis of the lure, to attract fish.

U.S. Pat. No. 2,853,826, dated Sep. 30, 1958, to John Romeo, details an “Audible Fishing Lure”. The audible fishing lure includes a simulated fish body having a tail assembly that is automatically rotated responsive to retrieval of the fishing lure through the water. The tail assembly is operative to actuate an audible signal which produces a continuous buzzing sound and vibration within the lure and within the immediate surrounding water area. However, the Romeo lure, like the Latham lure, used treble hooks, which were prone to snag in weeds.

U.S. Pat. No. 3,397,478, dated Aug. 20, 1968, to F. J. Lowes, Jr., details a “Fishing Lure” which includes a pair of spinners mounted in tandem on a wire portion, to the rear end of which wire portion is attached to hook and a skirt. As the lure is retrieved, the tandem-mounted spinners cause vibration of the lure body for attracting fish. However, the Lowes patent, also, taught the use of the treble hook, prone to catch in weeds.

U.S. Pat. No. 3,987,576, dated Oct. 26, 1976, to James W. Strader, details a “Fishing Lure Provided With An Elongated Flexible Wire Shaft.” The lure includes a connecting eye at one end and a hook located at the opposite end. A lead weight is disposed along the shaft, which weight is conically-shaped and is contained within a conically-shaped, plastic housing that forms a sound chamber. The shaft is provided with a clevis having a spinner attached thereto behind the lead weight and multiple ball-shaped bearings are provided on the shaft between the clevis and the covered lead weight. A weed guard is provided forward of the hook and the rubber skirt disguises the hook. The spinner, which is attached to the clevis, creates an uneven force around the flexible shaft when the lure is moved through the water, which force is transmitted along the shaft to the lead weight and the plastic cover, causing the lead weight to strike the interior of the cover for generating the sound. Not only did such lure have limited application, but also, the weed guard was not highly effective in preventing the lure snagging in weeds.

U.S. Pat. No. 4,747,228, dated May 31, 1988, to Johnnie Giovengo, Jr., details another fishing lure which is characterized by a cylindrically shaped body having a hook embedded herein and a skirt extending therefrom and further including a capsule provided with steel balls which move in the capsule responsive to retrieval of the lure, to create a rattling noise. Such lure had only limited application, and it is not truly pertinent to the present invention.

U.S. Pat. No. 5,024,019, dated Jun. 18, 1991 to Rust et al is somewhat more pertinent in showing an L-shaped wire harness having a pair of segments, with one segment attached to a lure body having a hook, and another segment attached to a rattle pod cavity filled with loose shot, which are designed to make noise attractive to fish. Although Rust et al teach different rattle pod configurations, none were configured to have the appearance of a minnow or small fish, and Rust et al do not teach the use of a second hook, which would have expanded the capability of their lure to catch fish.

The numerous disadvantages associated with these prior art lures have largely been eliminated by the present highly advantageous lure arrangement utilizing a pair of lure bodies, each equipped with a single hook configuration, which minimizes snagging in weeds, floating branches, logs and the like.

### SUMMARY OF THE INVENTION

A weedless fishing lure in accordance with this invention comprises first and second arms diverging from a juncture point, with means provided adjacent this juncture point for attaching the lure to a fishing line. A fish-resembling lure member or minnow is attached to the first arm, with this fish-resembling lure member having a hook attached to its lower portion. A spinner member or blade is attached behind the fish-resembling lure member, with the spinner member configured to produce motion when the lure is pulled through the water. This motion is transferred to the fish-resembling lure member, thereby to produce motion attractive to fish. A skirted lure or member is attached to the second arm of the lure body, and a hook is disposed adjacent the end of the second arm, at a location remote from the juncture point, and residing in this skirted member.

In accordance with this invention, the hook attached to the fish-resembling lure member and the hook disposed in the skirted member reside in a spaced-apart relationship in a common plane. Each of these hooks has a point, with the points disposed a spaced distance apart and facing forward, which is in the direction of travel of the hooks as the lure is pulled through the water.

The configuration of the arms of our lure is such as to enable our lure to easily pass through weeds without becoming entangled, and because the arms and their respective hooks reside in a common plane, our lure can easily rotate so as to pass over obstructions such as logs, floating branches and the like, without entanglement.

It is a primary object of this invention to provide a highly effective spinner bait combined with a crank bait, with the crank bait configured to have a fish-shaped body equipped with a hook, with this lure able to be fished even in weed-infested lakes and ponds.

It is another object of this invention to provide a weedless fishing lure that advantageously utilizes a pair of hooks, attached to separate arms, with these hooks residing in a plane common to the arms, and with one embodiment of this lure containing means serving to make noise attractive to fish.

It is another object of this invention to provide a new and improved weedless fishing lure featuring a spaced pair of single hooks residing in a common plane and positioned to assure the hooking of fish, without the need for treble hooks.

Yet another object of our invention is to provide a weedless, spinner bait lure which is characterized by a fish-resembling lure member upon which a first hook is mounted, with this hook residing in a spaced relationship with a second hook operatively associated with a skirted member.

It is yet another object of this invention to provide a weedless fishing lure featuring a spaced pair of single hooks residing in a plane common to the support means for the hooks, with this arrangement enabling the lure to rotate at such time as a floating obstruction is encountered, so that the lure can assumed a flattened condition and pass over the obstruction without snagging thereon.

It is yet still another object of this invention to provide a weedless fishing lure in which one embodiment advantageously utilizes a rattle member used with a spinner member, the rattle member functioning to make noise for attracting fish as a result of motion induced into the rattle member by the spinner, with a hook attached to the rattle member, and a second hook disposed in a spaced apart relationship to the first hook, and residing in a plane common to the first hook.

It is yet still another object of this invention to provide a weedless fishing lure in which one embodiment advantageously utilizes fish-resembling lure member whose interior contains a plurality of rattle members functioning to make noise for attracting fish as a result of motion provided by a spinner member, with a hook attached to this fish-resembling lure member, and a second hook disposed in a skirted member and residing in a spaced apart relationship to the first hook, and disposed in a plane common therewith.

These and other objects, features and advantages will become more apparent as the description proceeds.

### BRIEF DESCRIPTION OF THE DRAWINGS

FIG. 1 depicts a preferred embodiment of a lure in accordance with this invention, which involves a fish-resembling lure member or minnow to which a spinner is attached, with a hook attached to the fish-resembling lure member, and a second hook, contained in a skirted member, effectively mounted in a spaced apart relationship to the hook attached to the fish-resembling lure member;

FIG. 2 is a view revealing the relationship of the two hooks, and illustrating the fact that the hooks and their supporting arms reside in a common plane;

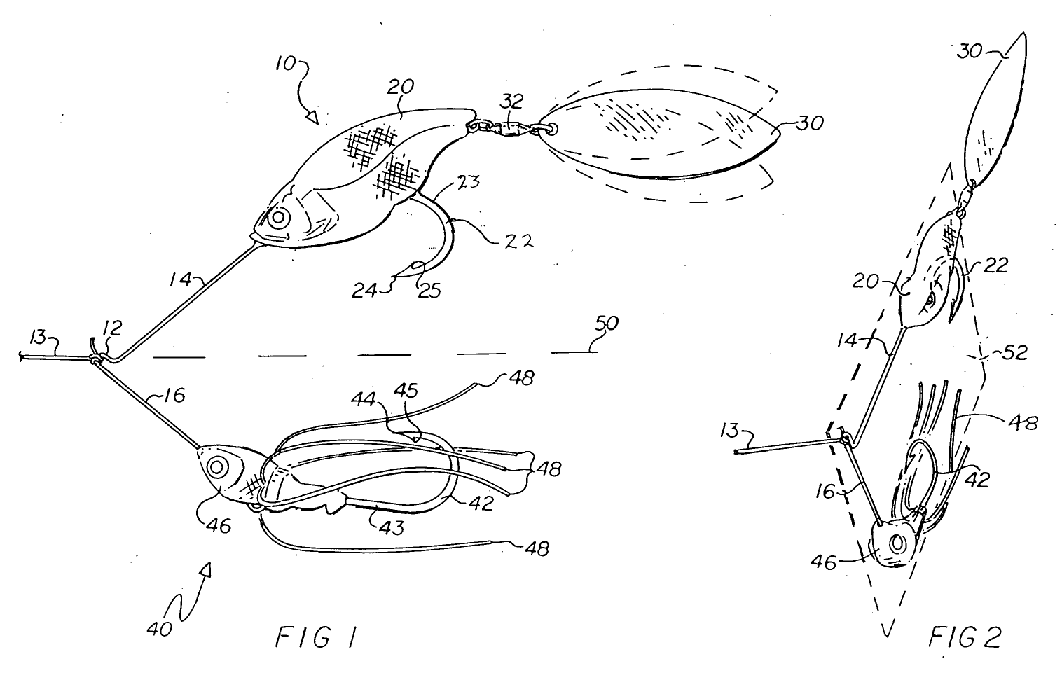

FIG. 1a is a view of the embodiment in which the fish-resembling lure member of FIG. 1 is to be seen as having a hollow interior, with this view being partially in section to reveal that contained in the hollow interior are small metal members or multiple shot elements designed to make a noise attractive to fish, particularly in the presence of motion provided by a spinner member;

FIG. 1b is an enlarged view of the spinner member of FIG. 1, revealing that it is somewhat cupped, being of the willow leaf type; and

FIG. 1c reveals an optional spinner member of the so-called Colorado type.

### DETAILED DESCRIPTION

With initial reference to FIG. 1, a weedless fishing lure 10 in accordance with this invention may be seen to involve an attachment point 12, at which a fishing line 13 is to be attached. First and second arms 14 and 16, respectively, diverge away from the attachment point or juncture point 12, with these arms preferably being created from a single piece of flexible wire bent into a right angle, or into a somewhat L-shaped configuration. However, it is not mandatory that the arms be made of flexible wire or that they form a right angle, The attachment point may be created by a loop formed in the wire, or by twisting the wire to form an eye-shaped attachment point.

A fish-resembling lure member or minnow 20 is attached to the first arm 14, and it will be noted from FIG. 1 that in the belly or lower portion of the member 20 a hook 22 is mounted. As will be noted, the hook 22 has a shank portion 23. Importantly, the point 24 of hook 22 points in the direction of travel of the lure through the water, which is toward the left as viewed in FIG. 1. Adjacent the point 24 is a barb 25.

As will be discussed hereinafter in more detail, a second hook 42 is also depicted in FIG. 1, which is operatively disposed on the second arm 16, and located a spaced distance away from the first-mentioned hook 22. This second hook 42 has a shank portion 43 and a point 44. Like the point 24 of the hook 22, the point 44 of hook 42 faces in the direction of travel of the lure through the water. Adjacent the point 44 is a barb 45.

A reference line 50 is indicated in FIG. 1, which may be regarded as generally horizontally disposed, and generally pointing in the direction of travel of the lure 10 through the water. The reference line 50 may be regarded as imaginary, being provided for the purposes of instruction, so line 50 obviously does not form a part of our lure.

With respect to the reference line 50, the hook 22 and the hook 42 are similarly placed or spaced, with the points of these hooks being somewhat closer to the reference line than is the shank 23 of hook 22, or the shank 43 of hook 42. However, there is no firm requirement that the points of the hooks 22 and 42 be disposed precisely equidistant from the reference line 50.

In accordance with one embodiment of this invention, the fish-resembling lure member 20 is of unitary construction, whereas in accordance with a second embodiment, discussed hereinafter in detail, the fish-resembling lure member or minnow member 20 has a hollow interior 26, visible in FIG. 1a. In this second embodiment of this invention, the interior of the member 20 contains a plurality of small, loosely-disposed metal members 28, as may be seen in FIG. 1a. The metal members may also be referred to as multiple shot elements.

It will be noted from FIG. 1 that a spinner member or spinner blade 30 is attached behind the fish-resembling lure member 20. A swivel 32 is utilized for the mounting of the spinner member 30, so that the spinner can spin and move freely as the lure is caused to travel through the water, without the fish-resembling lure member 20 needing to spin.

In one embodiment of our invention, depicted in FIG. 1b, the spinner member 30 is of oblong or of elliptical shape, having a bit of cupping rather than presenting a flat surface. The spinning motion created by the spinner member 30, when the lure 10 is caused to move through the water, is transferred to the fish-resembling lure member 20 as to cause it to have motion, such as a side-to-side motion. This type of motion results in the fish-resembling lure member 20 undertaking very realistic activity that is attractive to fish and causing fish to bite. The spinner member 30 is of the so-called willow leaf type, particularly adapted for relatively high speed of travel through the water. The approximate motion of the spinner member 30 as the lure 10 travels through the water is indicated in FIG. 1 by the use of dashed lines.

The direction of travel, as previously mentioned, is toward the left as viewed in FIG. 1, with the points of the hooks 22 and 42 pointing forwardly, and spaced similarly with respect to the previously-mentioned reference line 50 as well as being spaced a similar distance away from the attachment point (juncture point) 12.

With regard to the embodiment of this invention depicted in FIG. 1a, wherein the loosely disposed metal members or shot 28 are illustrated in the interior 26 of the fish-resembling lure member 20, it is to be understood that in the presence of motion brought about by the spinner member 30, the loosely disposed shot members or balls 28 produce a rattling noise attractive to fish, inducing fish to bite.

Resuming a discussion of FIG. 1, it will be noted in this figure that attached to the second arm 16 is a skirted lure member 40, and operatively associated with this lure member is the previously-mentioned hook 42. The hook 42 may be referred to as the second single hook, being firmly attached to a weighted member 46. The skirt, formed by a large number of tassel members 48, serves to conceal the hook point 44 and barb 45 and to attract fish. It is to be noted that the weighted member 46 is supported by the arm 16, with the hook 42 residing at a location approximately the same distance from the attachment point 12 as the first hook 22, as previously mentioned. However, there is no requirement that the hooks 22 and 42 be precisely the same distance from the attachment point. The weighted member 46 functions to cause the lure 10 to move through the water in approximately a vertical attitude, as illustrated in FIG. 1.

The substantial number of strips or tassels 48 attached to the weighted member 46 form what may be regarded as a skirt, and these tassels are caused to move about freely as the lure is pulled through the water, and to be attractive to fish, while at the same time serving to conceal the point 44.

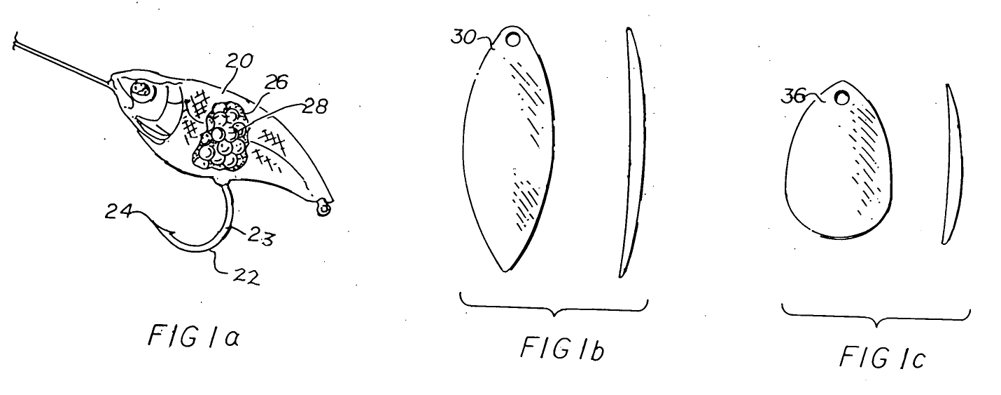

Our new lure is weedless, brought about by the fact that the hook 22 attached to the fish-resembling lure member 20 and the hook 42 disposed in the skirted member 40 reside in a common plane 52, along with the supporting means 14 and 16; note FIG. 2. The plane 52 may be regarded as a virtual plane or imaginary plane, and is provided for the purpose of clearly illustrating that the arms 14 and 16, as well as the hooks 22 and 42 and certain associated components reside in a single, common plane. Inasmuch as the points of the hooks 22 and 42 face in the direction of travel of the lure through the water, we prefer to regard the barbed points 24 and 44 as facing in a common direction. The fact that the hooks are substantially flat, and reside in a common plane with the arms 14 and 16, avoids the distinct problems associated with the use of certain other hooks, such as the treble hooks so commonly used in prior art lures, which type of hooks had the unfortunate characteristic of readily becoming snagged in weeds.

It is important to note that in addition to being weedless, our lure is quite able to move over branches, logs or other items floating at or near the surface of a lake or pond without snagging on such an obstruction. Upon a part of the lure 10, such as the lower arm (second arm) 16 contacting an obstruction, such as of the above-mentioned type, our lure 10 can easily turn something on the order of 90 degrees, and pass over the branch or other obstruction in what may be regarded as a flattened condition. Because the arms 14 and 16 are in the common plane 52 with the hooks 22 and 42, there is a minimal chance of the lure snagging on the obstruction.

As should now be clear, in accordance with the embodiment of this invention involving the fish-resembling lure member 20 having a hollow interior in which the plurality of shot or discrete metal members 28 are contained, a considerable amount of attraction for fish is created. The motion caused by the spinner member 30 or the spinner member 36 when the lure is moving through the water results in such motion being transferred to the fish-resembling lure member 20 so as to cause it to undertake motion, such as a side-to-side motion. This motion causes the small metal members 28 contained in the fish-resembling lure member to create a rattling noise as the lure is retrieved through a water body. This rattling noise, accentuated by the operation of the spinner 30 or 36, causes the lure to be particularly effective in murky water, where fish are attracted to a lure primarily by vibration, rather than by sight.

We claim:

1. A weedless fishing lure having an attachment point for a fishing line, said lure comprising mounting means for supporting first and second single hooks substantially equidistant from such attachment point, said first hook being mounted upon a fish-resembling lure member, a spinner member attached behind said fish-resembling lure member, said spinner member configured to produce motion when said lure is pulled through the water, which motion is transferred to said fish-resembling lure member, thereby to produce motion attractive to fish, said second hook being disposed in a plane common to said first hook, said second hook being operatively disposed in a skirted member.

2. The weedless fishing lure as recited in claim 1 in which said mounting means supporting said first and second single hooks are individual arms supporting said hooks in a spaced relationship in the common plane.

3. The weedless fishing lure as recited in claim 1 in which the hook disposed in said skirted member is directly attached to a weighted member, designed to keep the lure in a substantially vertical attitude when in use in water.

4. The weedless fishing lure as recited in claim 2 in which each of said hooks has a point, with the point of one hook facing in the same direction as the point of the other hook.

5. The weedless fishing lure as recited in claim 4 in which the points of said hooks point in the direction of travel as said lure is pulled through the water.

6. The weedless fishing lure as recited in claim 4 in which each of the points of said hooks are operatively associated with barbs.

7. The weedless fishing lure as recited in claim 4 in which the points of said hooks are mounted approximately equidistant from an imaginary reference line passing approximately through said attachment point.

8. The weedless fishing lure as recited in claim 1 in which said fish-resembling lure member has a hollow interior and contains a plurality of loosely-fitted metal members designed to create a noise attractive to fish in the presence of motion.

9. The weedless fishing lure as recited in claim 1 in which said first and second arms are made from a single piece of wire that has been configured to form said diverging arms.

10. The weedless fishing lure as recited in claim 1 in which said spinner blade is somewhat cup shaped.

11. A weedless fishing lure comprising first and second arms diverging from a juncture point, which juncture point is adapted for the attachment of the lure to a fishing line, a fish-resembling lure member attached to said first arm, said fish-resembling lure member having a hook attached to its lower portion, and a spinner member attached behind said fish-resembling lure member, said spinner member configured to produce motion when said lure is pulled through the water, which motion is transferred to said fish-resembling lure member, thereby to produce motion attractive to fish, and a skirted lure member attached to said second arm, a hook disposed adjacent the end of said second arm that is remote from said juncture point, and residing in said skirted lure member.

12. The weedless fishing lure as recited in claim 11 in which the hook attached to said fish-resembling lure member and the hook disposed in said skirted member reside in a spaced relationship and in a common plane.

13. The weedless fishing lure as recited in claim 11 in which the hook disposed in said skirted member is directly attached to a weighted member, designed to keep the lure in a substantially vertical attitude when the lure is in use in the water.

14. The weedless fishing lure as recited in claim 13 in which each of said hooks has a point, with the point of one hook facing in the same direction as the point of the other hook.

15. The weedless fishing lure as recited in claim 14 in which the points of said hooks point in the direction of travel as said lure is pulled through the water.

16. The weedless fishing lure as recited in claim 14 in which the points of said hooks are mounted approximately equidistant from said juncture point.

17. The weedless fishing lure as recited in claim 14 in which the points of said hooks are mounted approximately equidistant from an imaginary reference line passing approximately through said juncture point.

18. The weedless fishing lure as recited in claim 11 in which said fish-resembling lure member has a hollow interior and contains a plurality of loosely-fitted metal members designed to create a noise attractive to fish in the presence of motion.

19. The weedless fishing lure as recited in claim 11 in which said first and second arms are made from a single piece of wire that has been configured to form said diverging arms.

20. The weedless fishing lure as recited in claim 11 in which said spinner blade is cup shaped.
